(19) United States
(12) Patent Application Publication
(10) Pub. No.: US 2013/0255913 A1
(43) Pub. Date: Oct. 3, 2013

(54) TRANSPORT REFRIGERATION SYSTEM

(71) Applicant: Scott A. Zwiefel, Roberts, WI (US)

(72) Inventor: Scott A. Zwiefel, Roberts, WI (US)

(73) Assignee: Thermo King Corporation, Minneapolis, MN (US)

(21) Appl. No.: 13/435,728

(22) Filed: Mar. 30, 2012

(51) Int. Cl. F28F 9/007; B23P 15/26

(52) U.S. Cl. 165/67; 29/890.03

(57) ABSTRACT

A transport refrigeration system generally includes a support structure, a heat exchanger, and at least two pairs of mounts for mounting the heat exchanger to the support structure. The support structure is configured to be coupled to a transport container. The heat exchanger includes two sides and defines a longitudinal direction that extends from one side to the other side. Each pair of mounts includes a fixed mount coupled to one side of the heat exchanger, and a floating mount coupled to the other side of the heat exchanger, the floating mount positioned substantially opposite to the fixed mount in the longitudinal direction.

### BACKGROUND

Transport refrigeration systems such as for trucks, trailers, and shipping containers utilize a refrigerant to cool cargo within a cargo space of the cargo container. In operation, the refrigerant is compressed, directed through a first heat exchanger (e.g., a condenser) to remove the heat of compression to the atmosphere, directed through an expansion valve or other metering device, and then directed through a second heat exchanger (e.g., an evaporator) to absorb heat from air that is being circulated through the second heat exchanger and into the cargo space. The second heat exchanger cools the air which then cools the cargo within the cargo space as it circulates through the cargo space prior to returning to the heat exchanger.

Both heat exchanger experience temperature changes during periods of use and non-use. Such temperature changes cause the heat exchangers to undergo thermal expansion and contraction. When such a heat exchanger is fixedly mounted to a support structure, the heat exchanger is constrained from freely expanding or contracting, thus developing stresses around the mounts. These stresses may potentially result in cracks on the heat exchanger, the support structure, or both, reducing the service life of such components.

### SUMMARY

In one embodiment, a transport refrigeration system generally includes a support structure, a heat exchanger, and at least two pairs of mounts. The support structure is configured to be coupled to a transport container. The heat exchanger includes two sides and defines a longitudinal direction that extends from one side to the other side. Each pair of mounts includes a fixed mount coupled to one side of the heat exchanger, and a floating mount coupled to the other side of the heat exchanger, the floating mount positioned substantially opposite to the fixed mount in the longitudinal direction.

In another embodiment, a system for mounting a heat exchanger to a support structure generally includes at least two pairs of mounts. The heat exchanger includes two sides and defines a longitudinal direction that extends from one side to the other side. Each pair of mounts includes a fixed mount coupled to one side member, and a floating mount coupled to the other side member substantially opposite to the fixed mount in the longitudinal direction.

In still another embodiment, a method of coupling a heat exchanger to a support structure of a transport refrigeration system generally includes coupling the heat exchanger to the support structure with at least two pairs of mounts. The heat exchanger includes two sides and defines a longitudinal direction that extends from one side to the other side. Each side is coupled to a corresponding side of a support structure. Each pair of mounts includes a fixed mount coupled to one side of the heat exchanger, and a floating mount coupled to the other side of the heat exchanger. The floating mount is positioned substantially opposite to the fixed mount in the longitudinal direction.

Other aspects of the invention will become apparent by consideration of the detailed description and accompanying drawings.

### BRIEF DESCRIPTION OF THE DRAWINGS

FIG. 1 is a perspective view of a trailer with a transport refrigeration system attached thereto.

FIG. 2 is a front perspective view of a condenser assembly of a transport refrigeration system embodying the invention.

FIG. 3 is a rear perspective view of the condenser assembly of FIG. 2, showing fixed mounts on one side of the system.

FIG. 4 is a rear perspective view similar to FIG. 3, but showing floating mounts on the other side of the system.

FIG. 5 is an enlarged partial perspective view of one of the floating mounts of FIG. 4.

FIG. 6 is an enlarged cross-sectional view of the floating mount of FIG. 5.

It should be understood that the invention is not limited in its application to the details of construction and the arrangements of the components set forth in the following description or illustrated in the above-described drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

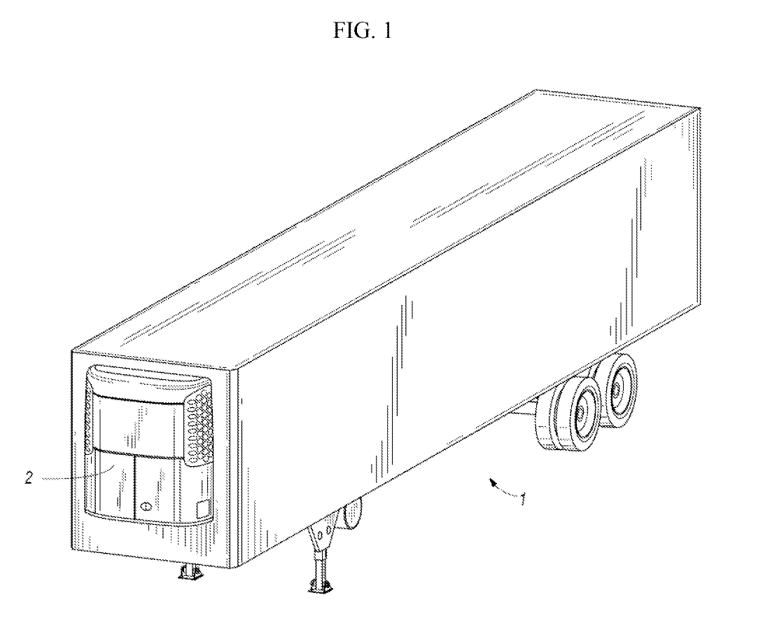

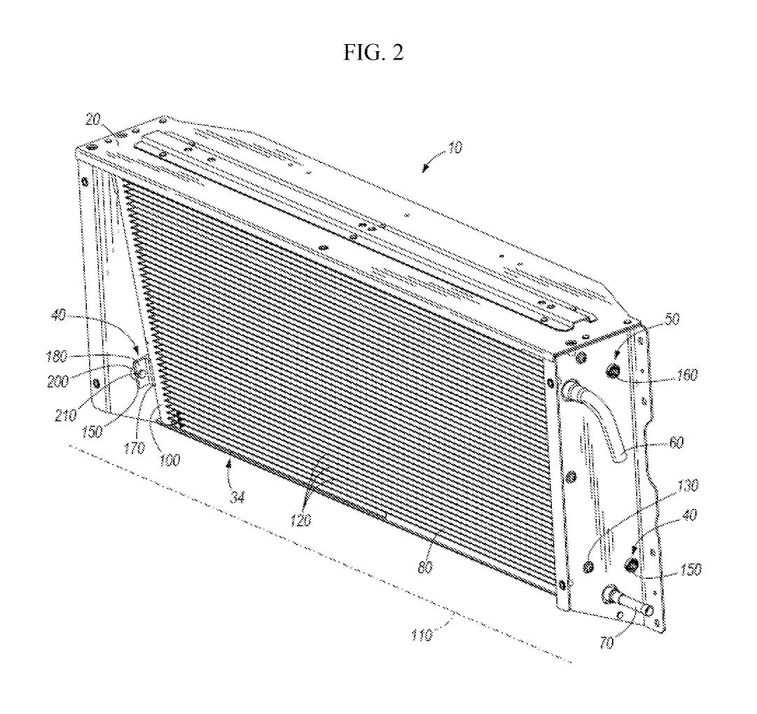

FIG. 1 is a perspective view of a trailer 1 with a transport refrigeration system 2 attached thereto. The transport refrigeration system 2 includes a condenser assembly 10 (not shown, see FIGS. 2-4) to remove the heat of refrigerant compression to the atmosphere. The refrigerant is directed through an expansion valve or other metering device, and then through an evaporator (not shown) to absorb heat from air that is being circulated through the evaporator and into the cargo space. Although FIG. 1 illustrates the transport refrigeration system 2 attached to the trailer 1, it is to be appreciated that the transport refrigeration system 2 may instead be attached to a truck, a shipping container, a rail car, or other transportable container capable of storing cargo.

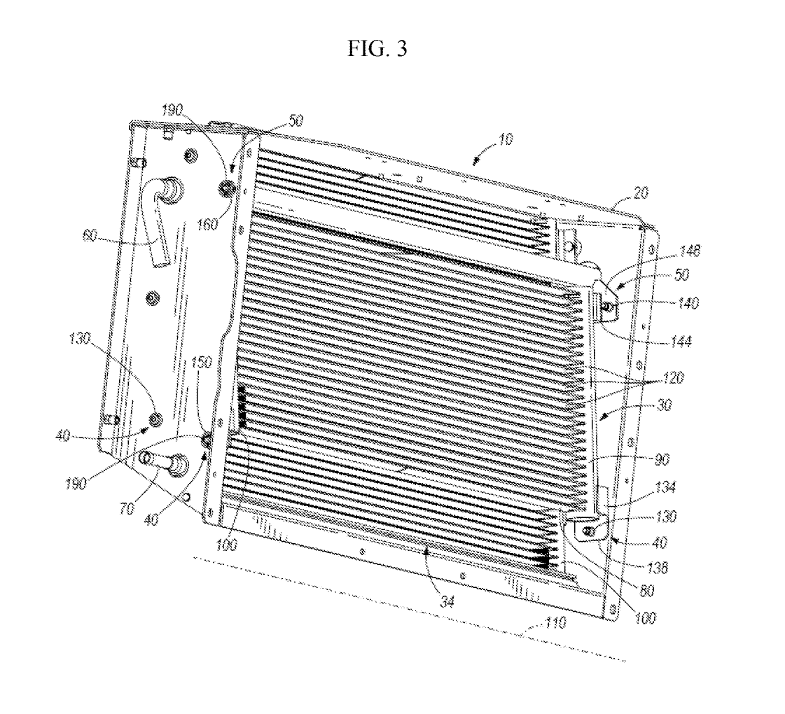

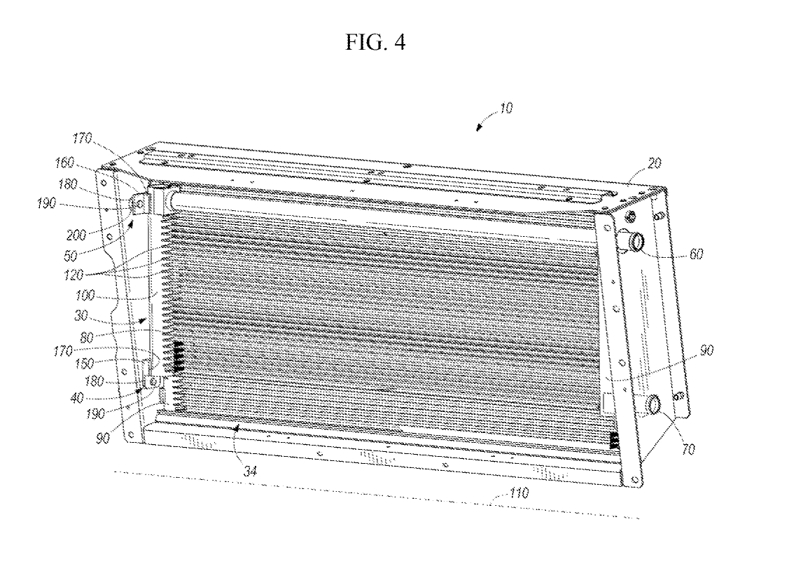

FIG. 2 is a front perspective view of the condenser assembly 10 for use in a transport refrigeration system for use with a truck, trailer, or shipping container to cool cargo. The condenser assembly 10 includes a support structure 20, one or more heat exchangers 30, 34, and at least two pairs of mounts 40, 50. The support structure 20 is configured to be coupled to a frame (not shown) of a vehicle or cargo container. In the construction illustrated in FIGS. 2-4, the assembly 10 includes two heat exchangers 30, 34, one at the front (shown in FIG. 2) and the other at the rear (not shown in FIG. 2; see FIGS. 3 and 4). As used herein, the terms “top,” “bottom,” “front,” “rear,” “side,” and other directional terms are not intended to require any particular orientation, but are instead used for purposes of description only. In the illustrated construction, the support structure 20 is a generally rectangular box frame with faces joined at right angles to each other. The two heat exchangers 30, 34 are arranged to be angled relative to these right angles, and extend substantially parallel to each other. In other constructions, however, the heat exchangers 30, 34 may extend substantially non-parallel to each other. In yet other constructions, the assembly 10 may include a single heat exchanger. In the illustrated construction, the heat exchanger 34 is a condenser of the transport refrigeration system 8, and the heat exchanger 30 is a radiator. However, in other constructions, any one of the heat exchangers 30, 34 can be of a type including, but not limited to, a condenser, an evaporator, and a radiator depending on the usage requirements or preferences for the particular transport refrigeration system 8.

Referring again to FIG. 2, the assembly 10 includes an upper pipe 60 and a lower pipe 70, one of which is an inlet pipe and the other is an outlet pipe. For example, the upper pipe 60 can be an inlet pipe and the lower pipe 70 can be an outlet pipe. The assembly 10 receives a refrigerant through the inlet pipe, and cools the refrigerant that passes through the coil assembly 80. The refrigerant is returned via the outlet pipe and supplied to an evaporator (not shown). Each heat exchanger 30, 34 includes two headers or side members 90, 100 and defines a longitudinal direction 110 that extends from one side member to the other side member. In the illustrated construction, the coil assembly 80 has a plurality of microchannel tubes 120 oriented along the longitudinal direction 110. In some constructions, the microchannel tubes 120 are made of aluminum.

As described above, the assembly 10 includes at least two pairs of mounts 40, 50 for respectively mounting each heat exchanger 30, 34 to the support structure 20. Each pair of mounts 40, 50 includes a fixed mount 130, 140, respectively, (see FIG. 3) coupled to one side or side member of the heat exchanger 30, 34, and a floating mount 150, 160, respectively, coupled to the other side or side member of the heat exchanger 30, 34. Each floating mount 140, 150 is positioned substantially opposite to the fixed mount 120, 130, respectively, in the longitudinal direction 110.

FIGS. 3 and 4 are rear perspective views of the assembly 10, showing the rear heat exchanger 30. For the purposes of the description, the mounting of the heat exchanger is generally the same between the front and rear heat exchangers 30, 34, and will be described with reference to the rear heat exchanger 30 shown in FIGS. 3 and 4 with the same effect as to the front heat exchanger 34 shown in FIG. 2. The first and the second pair of mounts 40, 50 are spaced apart from each other along a direction that is substantially perpendicular to the longitudinal direction 110. In the illustrated construction, the fixed mounts 130, 140 of the first and the second pair of mounts 40, 50, respectively, are on the same side member 90 of the assembly 10. In other constructions, however, the fixed mounts 130, 140 may be on different side members of the assembly 10. Referring to FIG. 3, each fixed mount 130, 140 includes a U-shaped member 134, 144, respectively, which receives a respective side member of the heat exchanger 30. Each U-shaped member 134, 144 is integrally formed with a base 138, 148, respectively, that extends substantially perpendicular to the legs of the U-shaped member 134, 144. In the illustrated construction, each base 138, 148 of the fixed mounts 130, 140, respectively, is coupled to the support structure 20 via screws. In other constructions, however, the heat exchanger 30 can be coupled to the support structure 20 at the fixed mounts 130, 140 by rivets. In yet other constructions, the heat exchanger 30 may be fixedly coupled to the support structure 20 at the fixed mounts 130, 140 using any suitable methods that may not require rivets or screws.

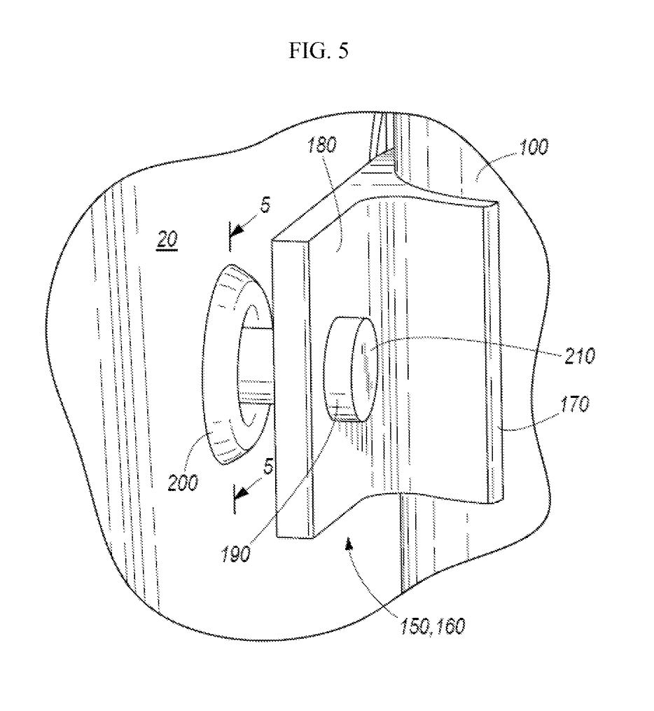

FIG. 5 is an enlarged partial perspective view of one of the floating mounts 150, 160. Each floating mount 150, 160 includes a U-shaped member 170 with two legs (only one leg is shown in FIG. 5), which receives a respective side member of the heat exchanger 30. In the illustrated construction, the U-shaped member 170 is integrally formed with a base 180 that extends substantially perpendicular to the legs of the U-shaped member 170. In other constructions, however, the U-shaped member 170 may be coupled to the base 180 using any suitable methods. The base 180 is coupled to the support structure 20 via pins 190, e.g., one on the front and the other on the rear (only one pin 190 is shown in FIG. 5; the other is positioned substantially symmetrical relative to the U-shaped member 170 and therefore would be behind the side member 100 in FIG. 5). In other constructions, however, the base 180 can be coupled to the support structure 20 via one or more pins 190 that are positioned adjacent the U-shaped member 170. Each pin 190 is coupled to the base 180 of the respective floating mount 150, 160, which in turn is coupled to the heat exchanger 30. A bushing 200 is coupled to the support structure 20 for slidably receiving the respective pin 190.

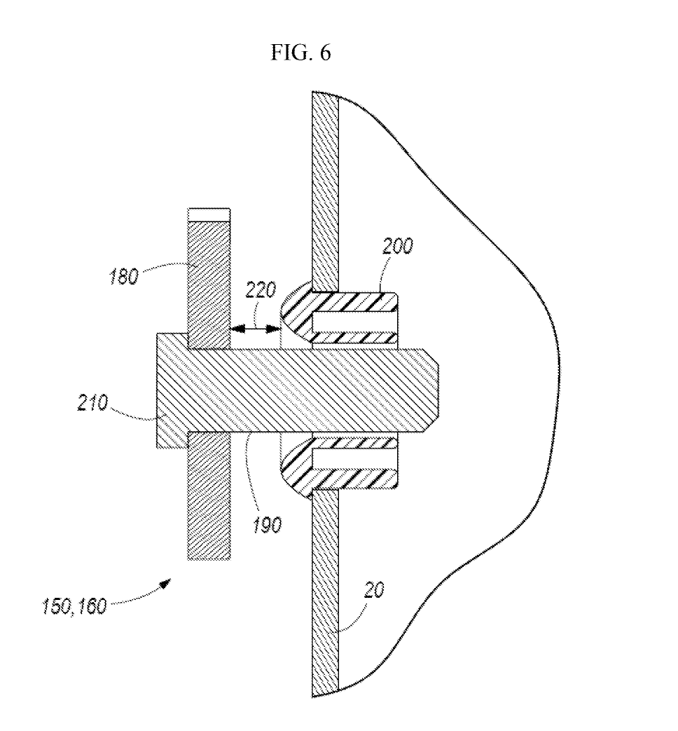

FIG. 6 is an enlarged cross-sectional view of one of the floating mounts 150, 160. The pin 190 includes a head portion 210 that is spaced apart from the bushing 200, defining a gap 220 therebetween. Once coupled to the support structure 20, the coil assembly 80 of the heat exchanger 30 may undergo thermal expansion or growth, and thermal contraction or shrinkage, depending on the temperature of the refrigerant in the inlet and outlet pipes 60, 70. The coefficient of thermal expansion of the heat exchanger 30 may be different from that of the support structure 20 on which the heat exchanger 30 is mounted. The gap 220 is so dimensioned as to allow the heat exchanger 30 to thermally expand and contract in the longitudinal direction 110. Thus, the heat exchanger 30 is coupled or secured to the support structure 20, but not constrained from expanding and contracting.

In some constructions, the floating mounts 150, 160 are substantially free of rubber. A rubber mount, such as a rubber grommet, may become dry in continued use, thereby becoming undesirably brittle and potentially failing over a short period. A floating mount substantially free of rubber may avoid this issue and thereby provide a longer service life. In some constructions, the floating mounts 150, 160 are formed of metal, so as to create a metal-on-metal contact between the pins 190 and the bushing 200, which contact may be suitably lubricated. In other constructions, however, the floating mounts 150, 160 can be molded or formed from any suitable plastic such as nylon, or can be made in other manners from other materials.

Although the invention has been described in detail with reference to certain preferred embodiments, variations and modifications exist within the scope and spirit of one or more independent aspects of the invention as described.

What is claimed is:

1. A transport refrigeration system comprising:
a support structure configured to be coupled to a transport container;
a heat exchanger including two sides and defining a longitudinal direction that extends from one side to the other side; and
at least two pairs of mounts, each pair including
a fixed mount coupled to one side of the heat exchanger, and
a floating mount coupled to the other side of the heat exchanger, the floating mount positioned substantially opposite to the fixed mount in the longitudinal direction.

2. The system of claim 1, wherein the system includes a first pair of mounts and a second pair of mounts, the first and the second pairs of mounts being spaced apart from each other along a direction that is substantially perpendicular to the longitudinal direction.

3. The system of claim 2, wherein the first pair includes a first floating mount, the second pair includes a second floating mount, and the first and the second floating mounts are on the same side of the heat exchanger.

4. The system of claim 3, wherein each floating mount includes a pin coupled to the heat exchanger and a bushing coupled to the support structure for slidably receiving the pin.

5. The system of claim 4, wherein the pin includes a head portion that is spaced apart from the bushing, defining a gap therebetween, and wherein the gap is so dimensioned as to allow the heat exchanger to thermally expand and contract in the longitudinal direction.

6. The system of claim 5, wherein the floating mount is substantially free of rubber.

7. The system of claim 1, wherein the heat exchanger is an aluminum microchannel coil having a plurality of microchannel tubes oriented along the longitudinal direction.

8. A system for mounting a heat exchanger to a support structure, the heat exchanger including two sides and defining a longitudinal direction that extends from one side to the other side, the system comprising:
at least two pairs of mounts, each pair including
a fixed mount coupled to one side member, and
a floating mount coupled to the other side member substantially opposite to the fixed mount in the longitudinal direction.

9. The system of claim 8, wherein the heat exchanger includes a first pair of mounts and a second pair of mounts, the first and the second pairs of mounts being spaced apart from each other along a direction that is substantially perpendicular to the longitudinal direction.

10. The system of claim 9, wherein the first pair includes a first floating mount, the second pair includes a second floating mount, and the first and the second floating mounts are one the same side of the heat exchanger.

11. The system of claim 8, wherein each floating mount includes a pin that is insertable through a bushing that is coupled to the support structure.

12. The system of claim 11, wherein the pin includes a head portion that is spaced apart from the bushing, defining a gap therebetween, and wherein the gap is so dimensioned as to allow the heat exchanger to thermally expand and contract in the longitudinal direction.

13. The system of claim 8, wherein the floating mount is substantially free of rubber.

14. The system of claim 8, wherein the heat exchanger is an aluminum microchannel coil having a plurality of microchannel tubes oriented along the longitudinal direction.

15. A method of coupling a heat exchanger to a support structure of a transport refrigeration system, the heat exchanger including two sides and defining a longitudinal direction that extends from one side to the other side, each side being coupled to a corresponding side of a support structure, the method comprising:
coupling the heat exchanger to the support structure with at least two pairs of mounts, each pair including
a fixed mount coupled to one side of the heat exchanger, and
a floating mount coupled to the other side of the heat exchanger, the floating mount positioned substantially opposite to the fixed mount in the longitudinal direction.

16. The method of claim 15, wherein the heat exchanger is coupled to the support structure with a first pair of mounts and a second pair of mounts, the first and the second pairs of mounts being spaced apart from each other along a direction that is substantially perpendicular to the longitudinal direction.

17. The method of claim 16, wherein the first pair includes a first floating mount, the second pair includes a second floating mount, and the first and the second floating mounts are on the same side of the heat exchanger.

18. The method of claim 17, wherein each floating mount includes a pin coupled to the heat exchanger and a bushing coupled to the support structure for slidably receiving the pin.

19. The method of claim 18, wherein the pin includes a head portion that is spaced apart from the bushing, defining a gap therebetween, and wherein the gap is so dimensioned as to allow the heat exchanger to thermally expand and contract in the longitudinal direction.

20. The method of claim 15, wherein the heat exchanger is an aluminum microchannel coil having a plurality of microchannel tubes oriented along the longitudinal direction.
